(19) United States
(12) Patent Application Publication
(10) Pub. No.: US 2007/0193357 A1
(43) Pub. Date: Aug. 23, 2007

(54) Apparatus and method for monitoring the condition of pipelines

(75) Inventors: Alf Daaland, Melhus (NO); Oystein Baltzersen, Trondheim (NO)

Correspondence Address: FOLEY AND LARDNER LLP;SUITE 500, 3000 K STREET NW, WASHINGTON, DC, 20007, US

(73) Assignee: STATOIL ASA

(21) Appl. No.: 10/574,710

(22) PCT Filed: Oct. 14, 2004
(86) PCT No.: PCT/NO04/00311

§ 371 Date: Apr. 5, 2006

(30) Foreign Application Priority Data
Oct. 30, 2003 (NO) 20034856

(51) Int. Cl. G01N 29/07

(52) U.S. Cl. 73/626; 73/628; 73/602

(57) ABSTRACT

Apparatus for condition control of a pipeline with a fluid flow pipe for transport of a fluid, comprising a plurality of ultrasonic transducers arranged in the vicinity of the external surface of the pipeline. By emitting, receiving and analyzing ultrasonic signals by means of ultrasonic transducers it is possible to perform a characterization of the pipeline, for example a measurement of the pipeline wall thickness. Ultrasonic transducers are arranged as an integral part of at least one tape.

### FIELD OF THE INVENTION

The present invention relates in general to monitoring the condition of subsea pipelines, and more particularly to monitoring corrosion in subsea pipelines, such as for example-wellflow pipelines.

Pipelines for transport of well fluids are exposed to corrosion of various kinds. The rate of corrosion may depend on production conditions, the amount of CO₂, H₂S, water cut, and the composition of the produced water.

Thus, it is of importance to be able to monitor the degree of corrosion in the pipeline throughout the entire life of the pipeline. Different methods and technologies exist for this purpose.

### PRIOR ART

Measurement of steel plate thicknesses by means of ultrasound is a conventional method, extensively used for example in the ship building industry. The method is also used for control of naval constructions. Control of pipeline wall thickness may be achieved by corresponding methods, using relatively simple and mobile equipment, such as for example described in International Patent Application No. WO 00/73739 A1, Det Norske Veritas.

US Patent Specification U.S. Pat. No. 5,440,929 describes an ultrasonic based system for measuring the thickness of steel bottom plates of a tank, and in particular for monitoring the corrosion of the bottom plates of oil storage tanks.

Apparatus for inspection of metal structures such as for example installed pipelines by means of ultrasonic waves, is also known.

European Patent Specification No. EP 0605952 A2 discloses for example an ultrasonic based inspection apparatus in the form of an ultrasonic scanning head, carried by a scanning truck which is mobile around a circular track surrounding the pipe.

A further example is disclosed in US Patent Specification U.S. Pat. No. 4,912,683, describing a method for acoustically measuring the wall thickness of tubular goods utilizing an acoustical transducer with a large bandwidth and high resonant frequency to measure the thickness of thin walls.

A monitoring apparatus and a method for downhole well monitoring of corrosion in a well bore pipe by means of ultrasound is also known.

The so called FSM technique (Field Signature Method), or electric resistance tomography disclosed in International Patent Application No. WO 02/39102 in the name of British Nuclear Fuels LTD., describes monitoring of corrosion induced loss of material by means of a plurality electrical resistance measurements.

The only commercially available solution on the market to-day known to the applicant, is based on the FSM®-technique, delivered by the company CorrOcean.

This known technique implies, however, several undesirable limitations, either in the form of use of mechanical movable parts for monitoring the state of the pipes, or in that the apparatus is not suitable for a simple mounting of a large number of transducers and cost effective and simple monitoring of pipelines over long periods of time while the pipes transport fluids.

A very limited number of commercially available solutions are known, implying that the existing techniques do not satisfy the desired requirements.

A main objective of the invention is to obtain a solution for monitoring the state of the pipeline which is less expensive and simpler than the available commercial solutions.

Another objective of the present invention is to obtain a novel apparatus and method for monitoring the condition of pipe shaped members, in particular subsea pipelines, installed in areas exposed to environmental loads and strains, such as for example a corrosive environment, both reducing the strength of the pipes and in worst case causing detrimental leakages of fluids transported through the pipe.

It is a specific objective of the invention to obtain an apparatus and a method for cheap, effective and continuous monitoring of corrosion of the pipeline throughout its entire life.

According to a first aspect of the invention, the above referenced objectives are achieved by mans of an apparatus for condition control of a pipeline, comprising a fluid flow duct for transport of a fluid. The condition control apparatus comprises a plurality of ultrasonic transducers arranged in the vicinity of the external surface of the pipe and, by transmission, receipt and analysis of the ultrasonic signals by means of the ultrasonic transducer, characterization of the pipeline, for example by measurement of the wall thickness of the pipeline, may be performed. A characterizing feature of the pipeline is that the ultrasonic transducers are arranged as an integral part of at least one tape.

Further embodiments according to this first aspect of the invention may be deducted from the dependent claims 2-17.

According to a second aspect of the invention, the objective of the invention is obtained by means of a condition control apparatus, comprising a pipeline including a fluid flow duct for transport of a fluid. Also, the apparatus comprises a plurality of ultrasonic transducer embedded in and protected by a surrounding polymer material, the polymer material serving the as protection of the external surface of the pipe. By emission, reception and analysis of the ultrasonic signals by means of the ultrasonic transducers it is possible to make a characterization of the pipeline, for example by measuring the wall thickness of the pipeline. According to such second aspect the invention is characterized in that the ultrasonic transducers are arranged as an integral part of at least one tape, and wherein the transducers are connected to an external driving, controlling and signal analyzing unit by means of an inductive connection means.

According to a third aspect of the invention a system for condition control of a pipeline for transport of a fluid is obtained, the system comprising an ultrasonic apparatus generating drive signals for several ultrasonic transducers for emission of ultrasound. An A/D-converter is connected to the ultrasonic transducers for converting analog signals from the ultrasonic transducers to digital data corresponding to the analog signals from the ultrasonic transducers and passing the digital data to a control and data analysis unit for analysis of the received data. The invention is characterized in that a plurality of ultrasonic transducers are arranged as an integral part of one or more tapes, the tapes being permanently attached on the external side of the pipeline wall and adapt to the pipe surface curvature during installation, the properties of the pipeline, such as for example possible reduction of the pipeline wall thickness or the properties of a weld or a joint, may be calculated by means of the digital data and a thickness calculating software module as a part of the data analysis unit.

Additional preferred embodiments of the system for condition control of a pipeline will be apparent from the dependent claims 20-21.

### DETAILED DESCRIPTION OF THE INVENTION

A detailed description of embodiments of the invention will be described below by means of examples of embodiments, referring to the enclosed drawings, in which:

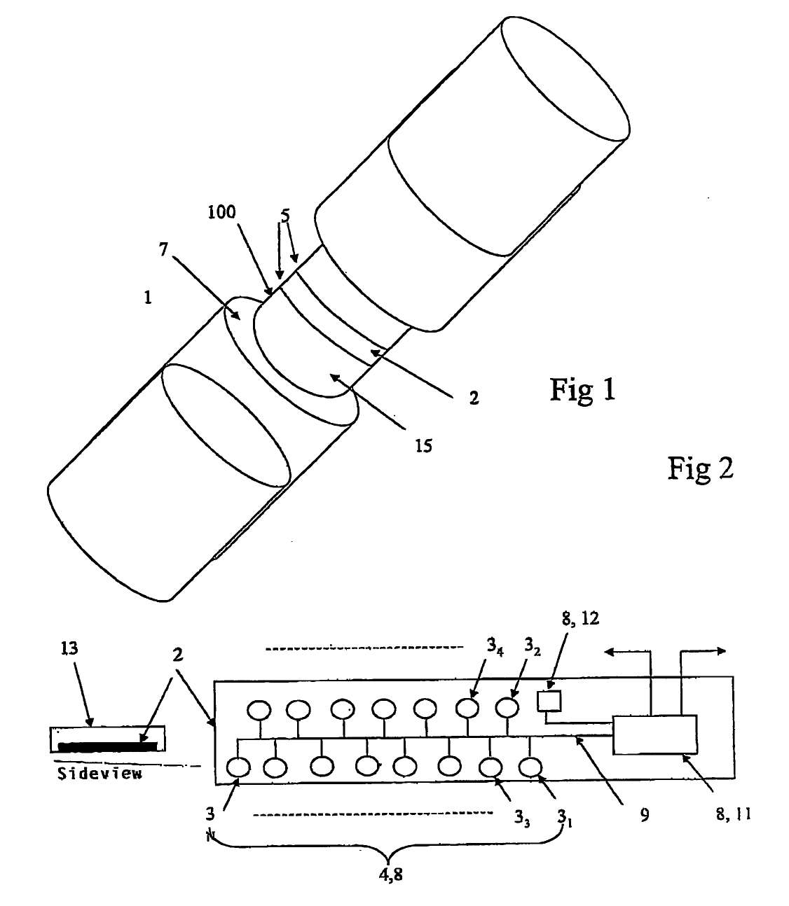

FIG. 1 shows an example of a monitoring apparatus according to the invention, in which the ultrasonic transducers are embedded in a field joint;

FIG. 2 shows a simplified view of an illustrated example, showing a plurality of ultrasonic transducers arranged in a array, for example on an electronic circuit card;

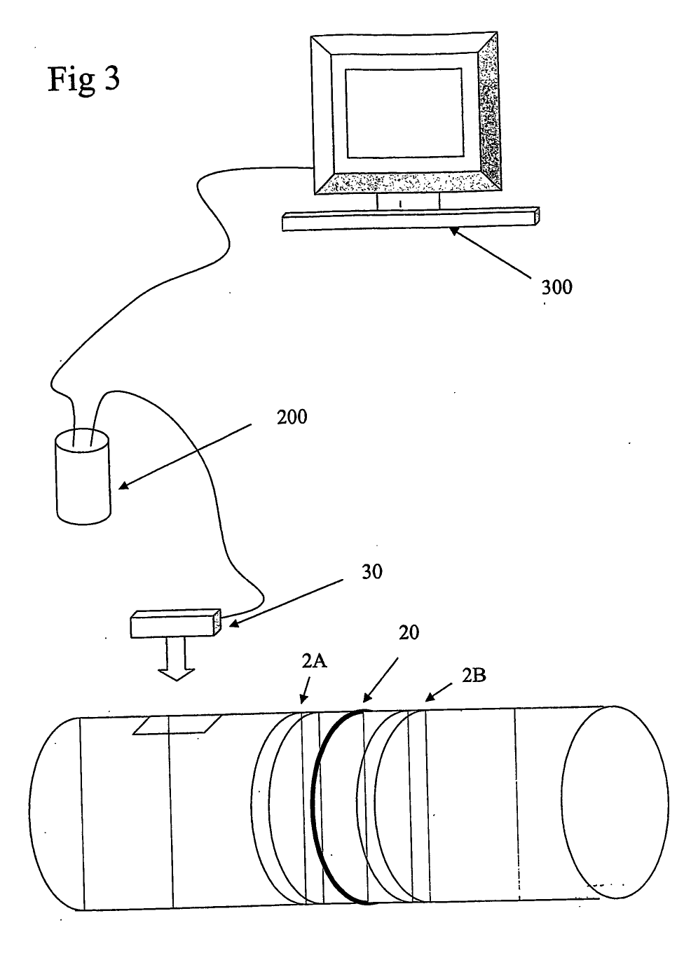

FIG. 3 shows a complete system according to the invention; and

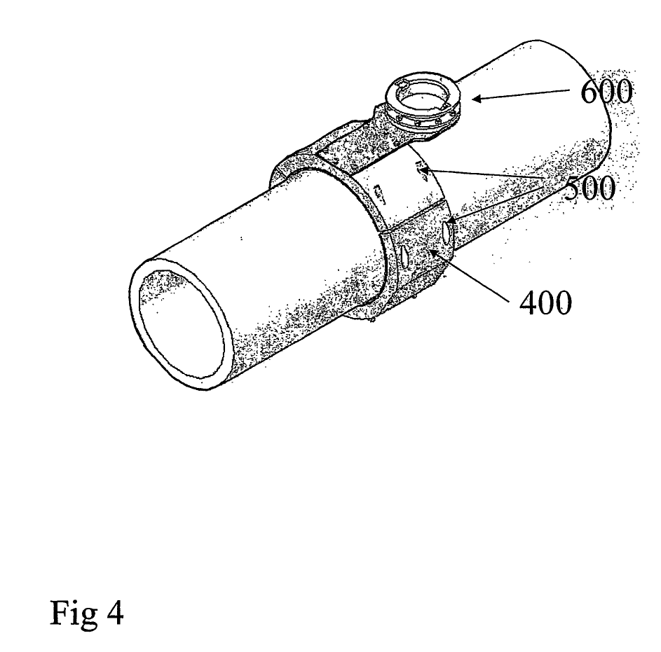

FIG. 4 shows an alternative embodiment of a monitoring apparatus where the sensors and the electronic members are arranged in a mechanical clamp.

An embodiment of the invention, as illustrated in FIG. 1 and 2, comprises an apparatus for monitoring the condition of a pipeline 1 which includes a fluid flow duct or pipe 15 for transport of a fluid. A plurality of ultrasound transducers 3₁-3_{N} are arranged on the external surface 100 of the pipe 15. The transducers 3₁-3_{N} will, according to a preferred embodiment be arranged in an array 4 on a tape 2. A specific feature of the invention is that ultrasound transducers 3₁-3_{N} are arranged as an integral part of at least one tape 2. The tape may be of a flexible and/or pliable type, intended to be attached to pipe by means of a clamping or attachment means 5, ref. FIG. 1. This clamping or attachment means 5 may be a mechanical band, for example a hose clamp, a metal strip of the type BAND-IT® (Trademark owned by BAND-IT IDEC Corporation), or any other type of clamping or attachment means with corresponding functions. When activating the transducers 3₁-3_{N} ultrasonic signals are emitted, transmitted through at least a part of the pipeline. By means of the ultrasonic transducers 3₁-3_{N} the ultrasonic signals transmitted through the at least a part of the pipeline are received, and the received ultrasonic signals are converted to analog electrical signals and possibly also further converted to digital signals, representing the analog signals. The signals are analysed and hence an analysis of the condition of the pipeline 1 may be performed.

It is of particular advantage that the ultrasonic transducers 3₁-3_{N} are arranged on a tape 2, making it possible in a simple manner to attach a plurality of transducers 3₁-3_{N} to the pipeline 1, such attachment of a single tape 2 replaces installation of separate and individual attachment of each ultrasonic transducer 3₁-3_{N}. Further, the tape 2 may easily be applied on surfaces of different shape, making reduced requirements with regards to shape or dimensions of the pipeline onto which the transducers are to be attached.

The ultrasonic transducers 3₁-3_{N} may typically be transducers being able to convert electrical signals to ultrasonic signals and convert ultrasonic signals to electrical signals.

The electrical signals resulting from a conversion of ultrasonic signals to electrical signals and where the ultrasonic signals have been propagated through the at least one part of the pipeline, will contain information which is representative for one or more conditions of that part of the pipeline through which the ultrasound has been propagated through. These electrical signals will typically contain information related to the pipeline dimensions and shape, such as thickness and boundary surface, and material properties, such as density and irregularities, such as damages of the pipeline structure.

According to a second embodiment of the invention the apparatus for condition control of a pipeline 1 with a fluid flow pipe 15 for transport of a fluid, comprises a plurality of ultrasonic transducers 3₁-3_{N} embedded in and protected by a surrounding material, preferably a polymer material, the material being a polymer material giving a good protection of the exterior 100 of the pipe. By using ultrasonic transducers 3₁-3_{N} it is possible to emit ultrasonic signals which propagate through the embedment material and at least through a part of the fluid flow pipe 15. At least one first ultrasonic transducer 3₁-3_{N} is used for emitting ultrasonic signals and at least a second ultrasonic transducer 3₁-3_{N} receives ultrasonic signals which has been transmitted through at least one part of the pipeline 15. The at least second ultrasonic transducer convert the ultrasonic signal to an analog electrical signal, and the analog electrical signal may possible be further converted to a digital signal. By means of either analog or digital signal processing the analog/digital signals are processed in such way that an analysis producing results which are representative for the condition of the pipeline, such as a measure of the wall thickness of the pipe, is performed.

As the ultrasonic transducers 3₁-3_{N} are embedded in and protected by the surrounding protection layer, it will be less beneficial to use a standard galvanic coupled electrical connection to other equipment, since a leakage from the surrounding environment along such electrical connection and into the tape with affixed ultrasonic transducers easily may occur, thereby causing damage to parts of the apparatus. In particular, it may be disadvantageous if the those parts of the apparatus being placed deep into the surrounding protection layer are damaged, since it will be a complicated operation to substitute said damaged parts.

By using an inductive connection one part of the inductive connection may be completely embedded in the surrounding protection layer and completely without openings towards the surrounding environment. This will provide proper protection of that part of the embedded apparatus for condition control embedded in the protection material.

The other part of the inductive connector will be arranged outside of the protection layer surrounding the pipeline, making access for substitution of said other part easier. By means of inductive connection both signals and electrical power may be supplied to the ultrasonic transducers and possible ancillary electrical circuits embedded in the protective coating surrounding the pipeline.

Various pipelines for transport of fluids, and in particular subsea pipelines, are assembled by a plurality of pipeline sections, each pipeline section being provided with surrounding coating 7, thereby providing insulation and protection. This protective coating 7 may for example be made of polypropylene.

When two of said pipeline sections are inter-connected, a field joint, i.e. a coating joint between said pipeline sections, must be established.

According to the invention the tape 2 provided with the ultrasonic transducers 3₁-3_{N} will be placed inside such field joints. It is particularly advantageous to place the ultrasonic transducers in such location for several reasons. Firstly, it is of particular interest to monitor the joints of the pipeline sections. Secondly, it is possible to place the ultrasonic transducers between otherwise completely standard pipe sections, if the ultrasonic transducers may be included as an integral part of the coating joint.

Thirdly, such placing in a field joint makes it possible to place the ultrasonic transducers 3₁-3_{N} relatively close to the internal surface of the pipeline transporting the fluid, since the transducers may be embedded deep into the protection coating.

The tape 2 with ultrasonic transducers 3₁-3_{N} is illustrated schematically in FIG. 2. The tape 2 may comprise a print card with electronic circuits/electrical elements (comprising conducting tracks and components 8) and ultrasonic transducers 3₁-3_{N}, the print card being sufficiently thin to be able to adhere to a typical pipe surface during installation. Alternatively, the tape may be made of a plate made of a suitable plastic material, and the transducers and the electronics may be mounted on said plate. Electronics and the transducers may then be covered by a protection coating made for example of silicone rubber. Such outer protection coating surrounds the print card and protects the print card, the ultrasonic transducers and the corresponding electrical circuits and components against external influence. The silicone protection may for example be produced in a casting process.

According to some embodiments of the invention the tape 2 may be attached to the pipeline 15 by means of various attaching means, such as for example clamps or other types of attachment means as will be obvious for a person skilled in the art.

The print card may for example be formed as a 16-channel electronic circuit board “ruler”. A plurality of ultrasonic transducers is arranged on the electronic circuit board, the transducers having for example a diameter of 10 mm and a resonance frequency of 4 MHz. Transducers are arranged in spaced relation, for example 15 mm apart. The transducers 3₁-3_{N} may be fixed to the print card by means of one of several commercially available types of glue which previously have successfully been used in connection with high temperature sensors, such types of glue being for example glue of the brand Locatite™, or an epoxy glue of the brand Araldite™. Alternatively, the ultrasonic transducers may be fixed to the print card by conducting epoxy glue, i.e. epoxy glue being mixed with electrically conducting material, such as silver. Electrically conducting epoxy glue has the inherent advantage that it also may be employed as a part of the electrical connection of the ultrasonic transducers.

Each ultrasonic transducer is connected to a channel multiplexer 11, made up by means of optically “solid state” relays, whereby the signal track/conductor track 9 to and from each individual ultrasonic transducer 3₁-3_{N} forms separate channels, wherein such several channels may be multiplexed.

The channel multiplexer 11 is designed in such way that up to 1000 channels, or 1000 ultrasonic transducers 3₁-3_{N}, may be addressed from the same drive unit.

A plurality of such tapes 2 may be interconnected, for example in series, by means of a simple conductor strapping whereby a large number of ultrasonic transducers may be interconnected along a common electrical connection.

Since the temperature at the point of measuring normally will be an important factor affecting the ultrasonic measurements and since the temperature in the fluid may vary a great deal, at least one of several print cards may also include a digital thermometer, for example of the type DS1621 (Dallas™). Such digital thermometer is read via the same system as used for choosing ultrasonic channels.

Corrosion in pipelines is often not evenly distributed around the pipe. Water is heavier than oil and gas, and hence the water will be collected at the lower section of the pipe, causing corrosion to occur faster at such sections. Due to this reason, it is useful to know the exact position of each individual transducer along the circumference. From a practical point of view it is not prior to the lying process easy to predict which part of the pipe section to be supported by the sea bed or which part pointing up. Hence, the electronic print card is provided with an electrical inclinometer, for example of the type ADXL202 (Analog Devices™). By means of measurements from three inclinometers, arranged at 120 degrees relationship along the circumference along the circumference of the pipe, it is possible to determine the angular position of each transducer.

Transfer of electrical energy and signals between the tape and the other components of the system externally arranged on the pipeline may be performed as described above, preferably by means of an inductive connection means. FIG. 3 illustrates positioning of an inductive connection means on the pipeline and the way such connector means is connected to a signal producer and receiver 200. Further, the signal producer and receiver 200 are connected to a data collecting and processing unit 300, for example a digital computer which may be of a transportable PC type.

The signal producer and receiver 200 comprise a signal producing unit which may be made as a ultrasound apparatus, adapted to produce and distribute drive signals to the various ultrasonic transducers, so that the ultra-sonic transducers produce ultrasound. The signal producer and receiver comprise typical also a receiver unit which may contain signal converting means converting the signals received from various ultrasonic transducers to signals suitable for subsequent signal processing. These signal converting means may typically comprise a A/D converter, but may in addition comprise a signal filter, a signal amplifier or any other signal converting means known to persons skilled in the art.

The other system components comprise thus instrumentation for transmitting and receiving signals to and from the ultrasonic transducers and may be placed remote from the tape and the pipeline. In stead of an inductive connection mean some standard electrical contact means may in certain embodiments be used for connecting the tapes to the other system components.

The instrumentation for transmitting and receiving signals to and from the ultrasonic transducers comprise typically a micro processor and a power supply, both arranged in a spaced relation from and mechanically un-coupled from the pipeline. Such configuration is favourable since the complexity of the parts of the system placed as an integral part of the pipeline is reduced.

Data acquisition and processing means 300, which may for example be a digital computer or a PC, may be provided with software to display either the raw signals received from the various transducers, processed signals from the various transducers or to display calculated results, for example the results of a thickness calculation of the pipeline or a calculated representation of a part of the pipeline, for example the surface structure of an inner surface of the pipe.

Data acquisition and processing means 300, which for example may be a digital computer or a PC, may also be provided with data storage, for example a data base, containing pre-stored ultrasonic responses, whereby a comparison between the real measurements and the pre-stored ultrasound responses may be performed for a real measurement, whereby known error symptoms may be recognized in the real measurement data. This enables automatic quality analyses of pipes by means of the collected signals from the ultrasonic transducers, which typically will be reflections and amplitude course.

A pipeline 1 to be condition controlled may be made in several ways. According to one method, a casting form may be arranged around the pipeline in order to establish a cavity between the pipeline and the moulding form. Said cavity is then filled, for example by means of an extruding process, forming a protective and insulating layer surrounding the pipeline. A tape 2, comprising a plurality of ultrasonic transducers placed on the exterior of the pipeline may be placed prior to installing the moulding form around the pipeline. In relation to the process of placing the ultrasonic transducers, electrical contact means may be installed in connection with the ultrasonic transducers, wherein a electrical coupling point subsequent to the extrusion process being obtained at the external surface of the extruded, protective layer. The electrical contact assembly may thus also be embedded in the protective layer such that said assembly is at least partly protected against influence from the environment. Said method has several similarities with a field joint process or a coating joint method.

The pipeline may be initially preheated, for example by means of induction heating, and a protective cover is applied, preferably of an epoxy material. Heating and applying a protective layer will normally be performed prior to attaching the tape to the pipeline.

The tape may also be glued to the exterior of the pipeline. Alternatively, the tape may be clamped to the exterior of the pipeline by means of clamping means 5.

Several tapes 2 may be placed at the same field joint or at two or more field joints in order to make it possible to inspect several parts of the pipeline.

Several tapes may be interconnected into a system, for example connected in series as previously described. These several tapes may be arranged in such way that they in general cover the entire circumference of a part of a pipeline.

In an alternative embodiment of the invention, for example as described in FIG. 4, several tapes provided with sensors and electronics are arranged as an integral part of a mechanical clamp, adapted to be clamped to the exterior surface of the pipeline, for example such that the sensors and the electronics are integrated in the clamp. In such case the clamp consists of three clamping parts 400, clamped to the pipe by means of bolts 500. An array 4 of ultrasonic transducers 3₁-3_{N} and electronics of the type as shown in FIG. 2 are shown in a protected position in each clamping part 400. A connecting element 600 for supply of signals or energy is fixed to one of the clamping parts.

The connecting element, which may be an electrical cable, may be arranged in such manner that it protrude out of the protecting coating 7, enabling electrical connection to the transducers 3₁-3_{N} subsequent to the extrusion process.

The connecting element may also be formed as a subsea contact, placed in such position that the contact subsequent to the extrusion process is embedded or cast into the protective coating. Such embedded or cast in contact means may thus be made accessible, for example by removing parts of the protective coating, whereby the contacting element is uncovered due to the removal of a part of the protective coating.

1-22. (canceled)

23. Means for condition control of a pipeline (1) incorporating a fluid flow pipe (15) for transport of a fluid, comprising a plurality of ultrasonic transducers (3₁-3_{N}) arranged in the vicinity of the external surface (100) of the pipe (15), and wherein a characterization of the pipeline (1), for example a measurement of the wall thickness, may be performed based on emission, receipt and analysis of the ultrasonic signals (3₁-3_{N}), characterized in that the ultrasonic transducers (3₁-3_{N}) are positioned as a part of at least one tape (2), the tape (2) being provided with a channel multiplexer (11) electrically connected to several of the transducers (3₁-3_{N}) by means of conducting tracks (9) on the tape (2), and wherein the channel multiplexer (11) provides a common electrical connection for said several transducers (3₁-3_{N}) between the tape (2) and its surroundings.

24. Means for condition control according to claim 23, wherein the transducers (3₁-3_{N}) are arranged in an array pattern (4).

25. Means for condition control according to claim 23, wherein the at least one tape (2) is attached on to the external surface (100) of the pipe (15) by means of a clamping or an attachment device (5).

26. Means according to claim 25, comprising a protective coating (7) for thermal and mechanical protection, the protective coating (7) arranged on the external surface (100) of the pipe (15) also functioning as a clamping or an attachment mean (5) or part of a clamping or an attachment means (5) for the tape (2).

27. Means according to claim 23, wherein the tape (2) comprises electrical elements, such as for example electrical/electronic components (8) and conducting tracks (9).

28. Means according to claim 23, wherein the tape (2) comprises a protective layer (13), for example a layer of silicon rubber, for thermal and mechanical protection.

29. Means according to claim 25, comprising a multiplexer (11) for multiplexing signals from the various transducers (3₁-3_{N})

30. Means according to claim 25, comprising a digital thermometer (12) for measuring the temperature, allowing characterizing to be performed with temperature compensation.

31. Means according to claim 25, comprising a plurality of tapes connected together in order to cover a larger part of the circumference of the pipe (15).

32. Means according to claim 23, wherein the tapes (2) cover a critical segment of the pipe (15) circumference.

33. Means according to claim 23, wherein the transducers (3₁-3_{N}) are covered by an external protective coating (7) for corrosion protection or insulation.

34. Means according to claim 23, wherein the ultrasonic transducers (3₁-3_{N}) are connected to an electrical contact mean (30) in order to provide a possibility of connection with external equipment (200,300).

35. Means according to claim 34, wherein the contact means (30) are placed on the external surface of the protective coating (7), whereby the contact means (30) may be accessible by removal of a part of the protective coating (7) surrounding the contact means.

36. Means according to claim 34, wherein the contact means (30) comprises an electrical cable extending out through the protective coating (7).

37. Means according to claim 34, wherein the contact means (30) comprises an protruding electrical cable terminated close to the external surface of the protective coating (30).

38. Means according to claim 36, wherein the cable is terminated in a subsea contact.

39. Means according to claim 23, comprising at least two tapes (2) for transducers, the first tape (2A) being arranged on one side of a weld or joint (20) and a second tape (28) being arranged on the other side of said weld or joint (20).

40. Means for condition control of a pipeline (1) with a fluid flow pipe (15) for transport of a fluid, comprising a plurality of ultrasonic transducers which are embedded in and protected by a surrounding polymer material, the polymer material functioning as protection of the exterior surface (100) of the pipe (15), and wherein emission, receipt and analysis of ultrasonic signals by means of transducers (3₁-3_{N}) are used for characterization of the pipeline, for example a measurement of the thickness of the pipeline,
characterized in that the ultrasonic transducers (3₁-3_{N}) are arranged as an integral part of at least one tape (2) and that the ultrasonic transducers (3₁-3_{N}) are connected to an external drive, control and signal analysis unit by means of an inductive connection means, and wherein the ultrasonic transducers (3₁-3_{N}) are embedded in and protected by a surrounding polymeric material, the polymeric material functioning as a protection of the exterior (100) of the pipe (15).

41. System for condition control of a pipeline for transport of a fluid, comprising an ultrasonic apparatus for generation of drive signals for a plurality of ultrasonic transducers emitting ultrasound, an A/D converter which also is connected to the ultrasonic transducers for converting analog signals from the ultrasonic transducers to digital data corresponding to the analog signals from the ultrasonic transducers and transmitting the digital data to a control and data analysis unit, analyzing the received signals, characterized in that a plurality of ultrasonic transducers are arranged as an integral part of one or more tapes, the tapes being permanently attached to the external surface of the pipeline wall and ply to the pipeline surface when clamped, the ultrasonic transducers (3₁-3_{N}) being embedded in and protected by a surrounding polymeric material, the polymeric material functioning as a protection for the external surface (100) of the pipe (15), the properties of the pipeline, such as for example possible reduction of pipeline thickness or properties at a weld or a joint, being calculated by means of the digital data and a software module for thickness calculation as a part of the data analysis unit.

42. System according to claim 41, wherein the software module for thickness calculations comprises software for an identification of the reflected acoustic signals in the digital data and calculating the time delay between emitted and reflected acoustic signals.

43. System according to claim 42, wherein the software module for thickness calculations comprises software for identification of the reflected acoustic signals in the digital data and for analyzing the amplitudes of the reflected acoustic signals.

44. Means for condition control of a pipeline (1) incorporating a fluid flow pipe (15) for transport of a fluid, comprising a plurality of ultrasonic transducers (3₁-3_{N}) arranged in the vicinity of the external surface (100) of the pipe (15), and wherein a characterization of the pipeline (1), for example a measurement of the wall thickness, may be performed based on emission, receipt and analysis of the ultrasonic signals by means of ultrasonic transducers (3₁-3_{N}), characterized in that the ultrasonic transducers (3₁-3_{N}) are positioned as a part of at least one tape (2), the tape being embedded in and protected by a surrounding polymeric material, the polymeric material functioning as protection of the external surface (100) of the pipeline (15).
